(19) United States
(12) Patent Application Publication
(10) Pub. No.: US 2005/0219473 A1
(43) Pub. Date: Oct. 6, 2005

(54) Advertising device

(76) Inventors: Yoshiyuki Moriyama, Suwa-shi (JP); Toshio Akahane, San Jose, CA (US); Yuji Takahashi, Matsumoto-shi (JP); Hiroshi Miyashita, Tokyo-To (JP); Satoshi Inoue, Chino (JP); Motonori Okumura, Shiojiri (JP); Masaru Kubota, Matsumoto (JP)

Correspondence Address: HARNESS, DICKEY & PIERCE, P.L.C., P.O. BOX 828, BLOOMFIELD HILLS, MI, 48303, US

(21) Appl. No.: 11/086,786

(22) Filed: Mar. 22, 2005

(30) Foreign Application Priority Data
Mar. 23, 2004 (JP) 2004-084649

(51) Int. Cl. G03B 21/26

(52) U.S. Cl. 353/79

(57) ABSTRACT

An advertising device includes a projection unit that houses an optical engine that emits projection light; and a display unit provided with screen panels that display an image when the projection light is projected from a rear surface side thereof. The projection unit and the display unit are separably integrated. Thereby, the maintenance and replacement of damaged parts can be applied with both units divided. Accordingly, these operations can be readily carried out.

### RELATED APPLICATIONS

This application claims priority to Japanese Patent Application No. 2004-84649 filed Mar. 23, 2004 which is hereby expressly incorporated by reference herein in its entirety.

### BACKGROUND

1. Technical Field

The present invention relates to an advertising device in which projection light is projected from a rear surface side of a screen to display an image.

2. Related Art

As an advertising device of this kind, an outdoor display plate system disclosed in JP-A No. 2003-149739 (see pages 2 to 4, and FIG. 3) is known. The outdoor display plate system is configured with a screen, a mirror and a rear projector (optical engine) housed in a closely sealed outdoor display plate body.

An existing outdoor display plate system has certain problems. That is, unlike a home rear projector that is used indoors, an outdoor display plate system is used in the open air abundant with dust and accompanied by a longer operating time. Accordingly, maintenance such as cleaning and lamp replacement is necessarily applied periodically. Furthermore, in a situation where the outdoor display plate system is installed along a road, the outdoor display plate system may be damaged (i.e., parts such as the screen, mirror and rear projector may be damaged). At such a time, the damaged parts has to be speedily replaced. However, in existing outdoor display plate systems, the rear projector (optical engine), screen and mirror are housed in a closely sealed outdoor display plate body. Accordingly, there is a problem in that maintenance and replacement of damaged parts can not be carried out.

The present invention is made in view of such problems and mainly intends to provide an advertising device that readily allows maintenance and replacement of damaged parts.

### SUMMARY

In order to achieve the above object, an advertising device of the present invention includes a projection unit that houses an optical engine that emits projection light; and a display unit provided with a screen that displays an image when the projection light is projected from a rear surface side thereof, the projection unit and the display unit being separably integrated.

Since the projection unit that houses the optical engine and the display unit provided with the screen are integrated separably from each other, with both units divided, maintenance and replacement of damaged parts can be readily carried out. Accordingly, these operations can be speedily accomplished.

Furthermore, in the above mentioned advertising device, the screen may have a non-planar display surface.

Since the display surface of the screen is formed non-planar, an image displayed on the screen can be obliquely observed. Accordingly, an advertising effect can be heightened.

Still furthermore, in the above mentioned advertising device, the display unit may be provided with a plurality of screens, and at least one of the projection unit and the display unit is provided with an optical system that optically divides the projection light and projects on the respective screens.

Since the optical system divides the projection light and projects respectively on the plurality of screens with one optical engine, an image can be simultaneously displayed on a plurality of screens. Accordingly, in comparison with, for instance, an advertising device that displays an image on one screen alone, the advertising effect can be further heightened.

Furthermore, in the above mentioned advertising device, the display unit may include a plurality of screens and at least one of the projection unit and the display unit includes an optical system that switches a reflection direction of the projection light and projects on the respective screens.

Accordingly, the optical system switches the projection light and projects on a plurality of screens respectively, and thereby, with a simple configuration, an image can be almost simultaneously displayed on a plurality of screens.

Still furthermore, in the above mentioned advertising device, the screen may be cylindrically formed and at least one of the projection unit and the display unit includes an optical system that continuously alters a reflection direction of the projection light and scans a projection area of the projection light in the screen with time.

When the optical system scans with time a display area of the projection light in a screen that is cylindrically formed, a novel image display in which the display area of an image in a cylindrical screen moves with time can be realized. Accordingly, the advertising effect can be further heightened.

### BRIEF DESCRIPTION OF THE DRAWINGS

FIG. 1 is a perspective view of an advertising device 1.

FIG. 2 is a block diagram showing a configuration of a projection unit 2.

FIG. 3 is a side sectional view of the advertising device 1.

FIG. 4 is a perspective view of an advertising device 1A.

FIG. 5 is a side sectional view of the advertising device 1A.

FIG. 6 is a perspective view of an advertising device 1B.

FIG. 7 is a side sectional view of the advertising device 1B.

### DETAILED DESCRIPTION

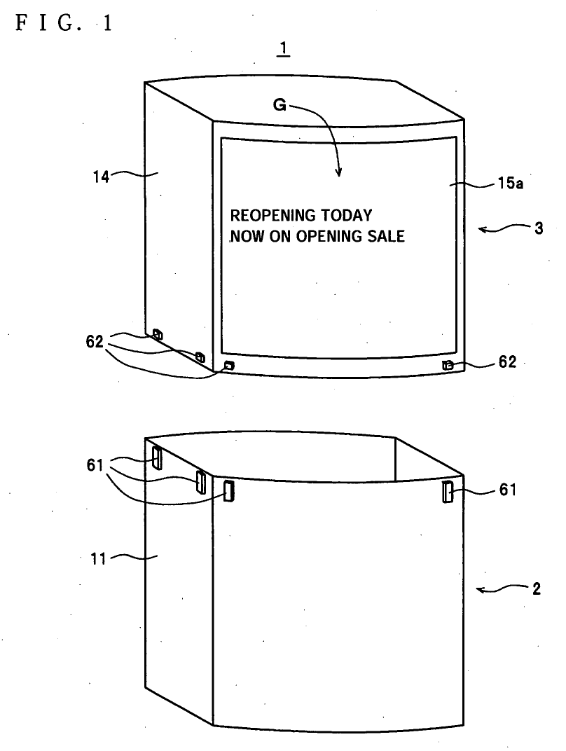

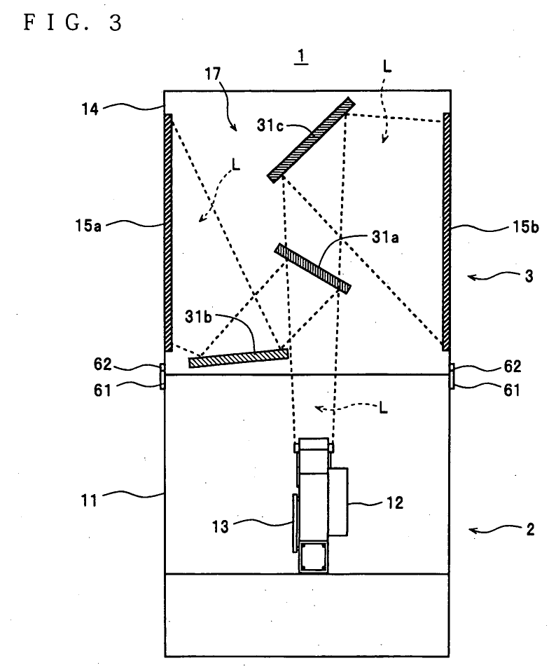

Best modes of an advertising device involving the invention will be explained with reference to the attached drawings. First, a configuration of an advertising device 1 will be explained. The advertising device 1 shown in FIG. 1 is an example of an advertising device configured to be capable of displaying an advertising image G (such as an image of letters as shown in FIGS. 1, 4 and 6 which are displayed when advertising devices 1, 1A and 1B operate) by means of a rear projection method. Specifically, the advertising device 1 is configured with a projection unit 2 and a display unit 3 that are separable from each other. The projection unit 2, as shown in FIG. 3, includes a chassis 11. An optical engine 12 and a circuit board 13 are stored in the chassis 11. The chassis 11, as shown in FIG. 1, is formed into a box shape having slightly curved front and back surfaces. A plurality of linking tags 61, 61 . . . are provided at a top end portion of the chassis 11. The linking tags 61 are used when a chassis 14 (to be described later) of the display unit 3 is attached. The optical engine 12 includes, for instance, an LED (Light Emitting Diode) as a light source, a light modulation device (as an example, a liquid crystal light valve having an incidence polarizing plate and an exit polarizing plate) that modulates light from the LED to projection light L based on display image data Dg2 (described later) outputted from the circuit board 13 and a projection lens (neither shown in the drawing) for enlarging projection light L.

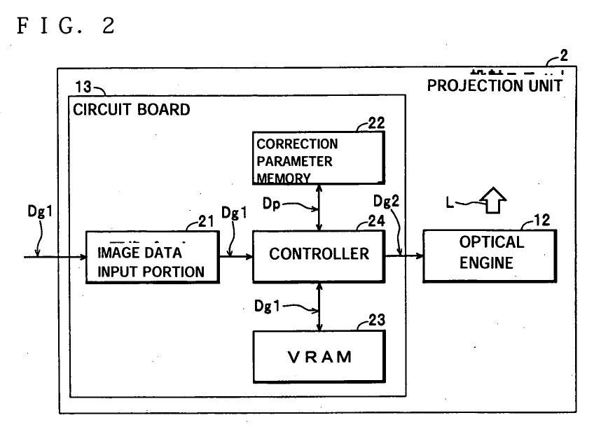

The circuit board 13, as shown in FIG. 2, includes an image data input portion 21, a correction parameter memory 22, a VRAM 23 and a controller 24. The image data input portion 21 inputs display image data Dg1 through a LAN (Local Area Network) from, for instance, a server outside of the advertising device 1. The correction parameter memory 22 memorizes a correction parameter Dp that is used in the image data correction process carried out by the controller 24. The VRAM 23 temporally memorizes the display image data Dg1 inputted to the image data input portion 21 under the control of the controller 24. The controller 24 controls the optical engine 12. Furthermore, the controller 24 instructs the VRAM 23 to memorize the inputted display image data Dg1. Still furthermore, the controller 24, when displaying the image G (allowing the projection light L to be emitted from the optical engine 12), applies the image data correction process to the display image data Dg1 read from the VRAM 23 to correct to display image data Dg2 for displaying the image G corresponding to curvatures of screen panels 15a and 15b described later, and outputs to the optical engine 12.

The display unit 3 includes, as shown in FIG. 3, a chassis 14 and screen panels 15a and 15b (sometimes hereinafter referred to simply as “screen panel 15” when no distinction is made therebetween) disposed respectively in the respective openings of a front surface and a back surface of the chassis 14. An optical system 17 is accommodated in the chassis 14. The chassis 14, as shown in FIG. 1, similarly to the chassis 11 of the projection unit 2, is formed into a box-shape having a slightly curved front surface and back surface. Furthermore, linking tags 62, 62 . . . that engage with the respective linking tags 61 of the chassis 11 are attached at a lower end portion of the chassis 14. In this case, as shown in FIG. 3, when the display unit 3 is placed above the projection unit 2 and the respective linking tags 61 and the respective linking tags 62 are engaged with each other, both units 2 and 3 can be separably integrated.

The screen panel 15 which corresponds to a screen in the invention receives projection light L projected from a back surface side and displays an image G thereon. In this case, the screen panel 15 is constituted with, for instance, a Fresnel lens that converts the projection light L into substantially parallel light, a lenticular lens that converts parallel light into expanding (diffusing) light and a resin plate that allows the expanding light to go through and functions as a protection plate that protects the lenticular lens (none are shown in the drawing). Furthermore, in the screen panel 15, a display surface thereof is formed into a non-planar shape that is curved with the same curvature as that of a front surface and a back surface in the chassis 14. The optical system 17, as shown in FIG. 3, is constituted with a half-mirror 31a and reflection mirrors 31b, 31c (sometimes hereinafter referred to as “mirror 31” when no distinction is made therebetween). The half-mirror 31a is disposed on an optical path of the projection light L emitted from the optical engine 12, partially reflects the projection light L toward the reflection mirror 31b and allows portions other than the partially reflected portion in the projection light L to transmit. The reflection mirror 31b reflects the projection light L reflected by the half-mirror 31a toward a back surface of the screen panel 15a. The reflection mirror 31c is disposed on an optical path of the projection light L that goes through the half-mirror 31a and reflects the projection light L passing through the half-mirror 31a toward a back surface of the screen panel 15b.

An overall operation of the advertising device 1 will now be explained with reference to the drawings. In the advertising device 1, as shown in FIG. 2, when an electric power source is turned on, the controller 24 instructs the display image data Dg1 to be inputted through LAN to the image data input portion 21. Subsequently, the controller 24 instructs the VRAM 23 to memorize the display image data Dg1 inputted to the image data input portion 21. Then, the controller 24 reads the display image data Dg1 from the VRAM 23 and the correction parameter Dp from the correction parameter memory 22 and carries out the image data correction process. In the image data correction process, the controller 24 corrects the display image data Dg1 based on the correction parameter Dp to generate display image data Dg2 that can display without generating distortion of the image G caused by the curvatures of the screen panels 15a and 15b, and outputs to the optical engine 12.

The optical engine 12 emits projection light L for displaying the image G based on the display image data Dg2. At this time, as shown in FIG. 3, the half-mirror 31a of the optical system 17 partially reflects the projection light L toward the reflection mirror 31b and allows the remaining projection light L to go through. Furthermore, the reflection mirror 31b reflects the projection light L reflected by the half-mirror 31a toward a back surface of the screen panel 15a. Thereby, the projection light L is projected toward the back surface of the screen panel 15a and thereby the image G is displayed. Still-furthermore, the reflection mirror 31c reflects the projection light L passing through the half-mirror 31a toward a back surface of the screen panel 15b. Thereby, the projection light L is projected toward the back surface of the screen panel 15b and thereby the image G is displayed on the screen panel 15b. In this case, the controller 24 applies the image data correction process to correct the display image data Dg1, the optical engine 12 emits the projection light L based on the display image data Dg2 after correction, and thereby the image G can be displayed without generating distortion due to the curvatures of the screen panels 15a and 15b. Furthermore, since display surfaces of the screen panels 15a and 15b are formed into a non-planar shape that is curved with a predetermined curvature, the image G displayed on the screen panels 15a and 15b can be observed from an oblique direction as well.

On the other hand, when a back surface of the screen panel 15 or a reflection surface of the mirror 31 is contaminated with, for instance, dust, as shown in FIG. 1, the respective linking tags 61 are disengaged from the respective linking tags 62 and thereby the projection unit 2 and the display unit 3 are divided (separated). Subsequently, after maintenance such as removal of contamination of the screen panel 15 or the mirror 31 is carried out, the display unit 3 is disposed above the projection unit 2, the respective linking tags 61 are engaged with the respective linking tags 62 respectively, and thereby both units 2 and 3 are linked. Furthermore, when, for instance, a light source of the optical engine 12 breaks down, similarly to the above, the projection unit 2 and the display unit 3 are separated and the light source is replaced, and also when, for instance, parts such as the screen panel 15, the mirror 31 and the optical engine 12 are damaged, similarly to the above, the projection unit 2 and the display unit 3 are separated and damaged parts are replaced. In this case, in the advertising device 1, the projection unit 2 and the display unit 3 that are normally integrated are separably constituted. Accordingly, maintenance and replacement can be speedily and readily carried out. When the parts such as the screen panel 15, the mirror 31 or the optical engine 12 are damaged, the projection unit 2 or the display unit 3 is replaced as a complete unit, whereby the replacement can be further speedily carried out.

Thus, according to the advertising device 1, the projection unit 2 that stores the optical engine 12 and the display unit 3 provided with the screen panel 15 are separably integrated. Accordingly, with both units 2, 3 separated, the maintenance or the replacement of the damaged parts can be carried out. As a result, these operations can be speedily and readily carried out.

Furthermore, since the display surface of the screen panel 15 is formed non-planar, the image G displayed on the screen panel 15 can be observed from an oblique direction. Accordingly, the advertising effect can be sufficiently heightened.

Still furthermore, the optical system 17 having the half-mirror 31a and the reflection mirrors 31b, 31c divides the projection light L to project the divided projection light L on the screen panels 15a, 15b. Thereby, with one optical engine 12, the image G can be simultaneously displayed on two screen panels 15a, 15b. Accordingly, in comparison with, for instance, an advertising device in which an image is displayed on one screen, the advertising effect can be further heightened.

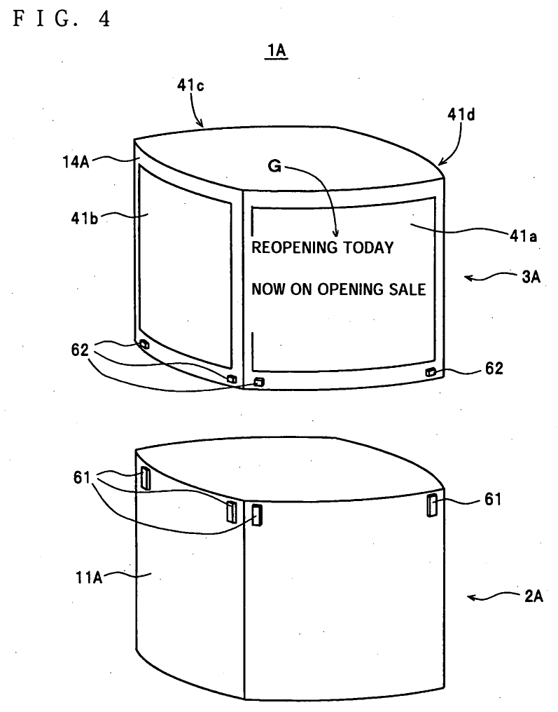

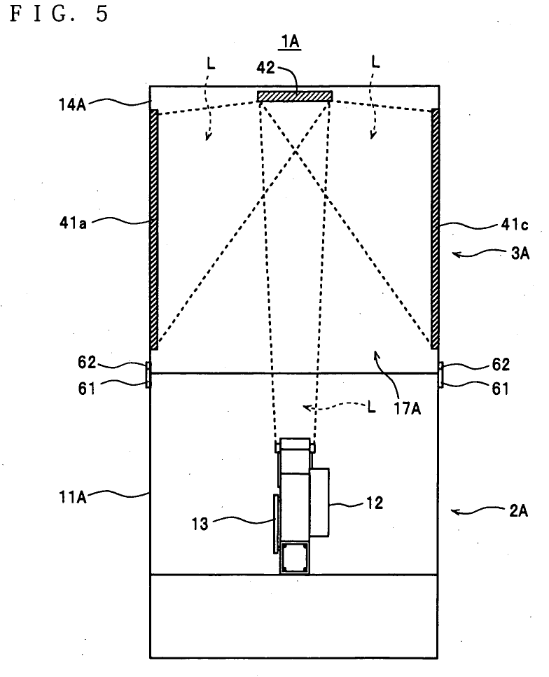

An advertising device 1A shown in FIG. 4 will be explained. In the advertising device 1A and an advertising device 1B described later, similarly to the advertising device 1, fundamentally, the present invention is applied. Accordingly, as to respective constituents that are the same as that of the advertising device 1, the same reference numerals are given and duplicate explanation will be omitted. The advertising device 1A, as shown in the same drawing, is constituted including a projection unit 2A and a display unit 3A. The projection unit 2A, as shown in FIG. 5, includes a chassis 11A, and an optical engine 12 and a circuit board 13 are housed in the chassis 11A. The chassis 11A, as shown in FIG. 4, is formed into a box shape having a slightly curved front surface, back surface and both side surfaces.

The display unit 3A, as shown in FIGS. 4 and 5, includes a chassis 14A and screen panels 41a through 41d (sometimes hereinafter referred to as “screen panel 41” when no distinction is made therebetween) that are respectively disposed in openings of a front surface, a back surface and both side surfaces in the chassis 14A. Furthermore, an optical system 17A is stored in the chassis 14A. The chassis 14A, as shown in FIG. 4, similarly to the chassis 11A of the projection unit 2A, is formed into a box shape having a slightly curved front surface, back surface and both side surfaces. In this case, as shown in FIG. 5, the display unit 3A is disposed above the projection unit 2A, and the respective linking tags 61 and the respective linking tags 62 are engaged respectively, and thereby both units 2A, 3A are separably integrated. The screen panel 41 corresponds to the screen in the invention and the display surfaces thereof are formed into non-planar shapes that are curved with curvatures that are the same as that of a front surface, a back surface and both side surfaces in the chassis 14A. The optical system 17A, as shown in the same drawing, is constituted with an optical element 42. The optical element 42 is disposed on a optical path of the projection light L emitted from the optical engine 12 and, under the control of the controller 24, swiftly repeats an operation of switching a reflecting direction of the projection light L, and thereby the project light L is swiftly switched and sequentially projected on the screen panels 41a through 41d. In this case, the controller 24 carries out the data conversion process and converts display image data Dg2 synchronizing with the switching due to the optical element 42 so that the image G may not be displayed inverted.

In the advertising device 1A, the controller 24, similarly to the operation of the advertising device 1, carries out the image data correction process and generates the display image data Dg2 for displaying the image G without distortion on the screen panels 41a through 41d. At this time, the controller 24 further carries out the data conversion process, and, while converting the display image data Dg2 in synchronization with the switching due to the optical element 42 so that the image G may not be displayed inverted, outputs to the optical engine 12. In accordance with this, the optical engine 12, as shown in FIG. 5, based on the display image data Dg2, emits the projection light L for displaying the image G. At this time, the controller 24 instructs the optical element 42 to carry out the switching. Thereby, the projection light L, while rapidly switching, is projected in this order on the screen panels 41a through 41d and thereby the image G is substantially simultaneously displayed on the respective screen panels 41a through 41d. According to the advertising device 1A, the optical element 42 of the optical system 17A switches the projection light L to project on the respective screen panels 41a through 41d. Accordingly, with a simple configuration, the image G can be almost simultaneously displayed on the respective screen panels 41a through 41d.

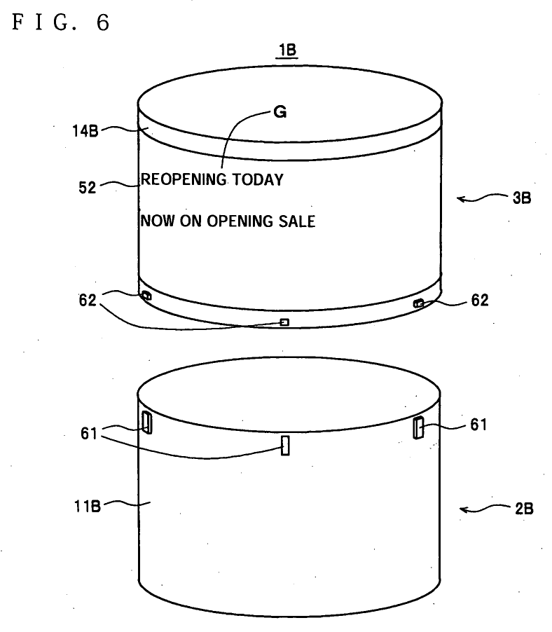

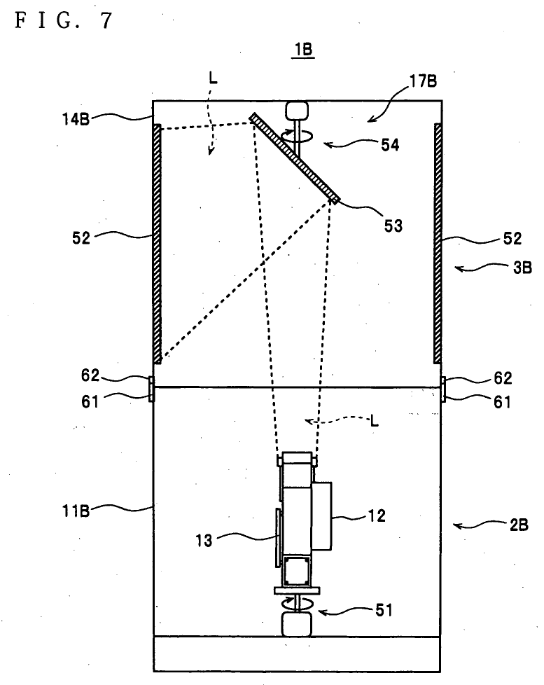

An advertising device 1B shown in FIG. 6 will now be described. The advertising device 1B, as shown in the same drawing, is constituted of a projection unit 2B and a display unit 3B. The projection unit 2B has a bottomed cylindrical chassis 11B having an opening at an upper portion, and, as shown in FIG. 7, an optical engine 12, a circuit board 13 and a rotation mechanism 51 are housed inside of the chassis 1B. In this case, the rotation mechanism 51, under the control of the controller 24, rotates the optical engine 12. The display unit 3B has a bottomed cylindrical chassis 14B having an opening at a lower portion thereof, and, as shown in FIG. 6, a screen panel 52 is cylindrically disposed on a side face of the chassis 14B. Furthermore, an optical system 17B is housed inside of the chassis 14B. In this case, as shown in the same drawing, the display unit 3B is disposed on the projection unit 2B, the respective linking tags 61 and the respective linking tags 62 are engaged respectively to separably integrate both units 2B, 3B. The screen panel 52 corresponds to the screen in the invention and is formed into a cylinder having a diameter almost the same as that of the chassis 14B. The optical system 17B, as shown in the same drawing, is constituted with a reflection mirror 53 and a rotation mechanism 54. The reflection mirror 53 is disposed on an optical path of the projection light L emitted from the optical engine 12 inclined to a horizontal plane with a predetermined angle and reflects the projection light L toward a portion of a region in the screen panel 52. The rotation mechanism 54, in accordance with the control of the controller 24, rotates the reflection mirror 53 in an inclined state.

In the advertising device 1B, the controller 24, similarly to the operation of the advertising devices 1, 1A, carries out the image data correction process to generate display image data Dg2 for displaying without generating the distortion of an image G caused by the curvature of the screen panel 52, and outputs to the optical engine 12. Subsequently, the optical engine 12 emits the projection light L for displaying an image G based on the display image data Dg2. At this time, the reflection mirror 53 reflects the projection light L toward a portion of a region in a back surface of the screen panel 52. Thereby, as shown in FIG. 6, the image G is displayed on a portion of a region of the screen panel 52. Subsequently, the controller 24 instructs the rotation mechanism 51 to rotate the optical engine 12 and the rotation mechanism 54 of the optical system 17B to rotate the reflection mirror 53 at the same rotation speed as that of the optical engine 12 due to the rotation mechanism 51. At this time, due to the rotation of the reflection mirror 53, a reflection direction of the project light L is continuously altered, and thereby a projection region of the projection light L in the cylindrical screen panel 52 is moved with time. Thereby, the image G is displayed as if it moves in a display surface of the screen panel 52. According to the advertising device 1B, the optical system 17B continuously alters a reflection direction of the projection light L to move a projection region of the projection light L in the cylindrical screen panel 52 with time. Thereby, a novel image display in which the image G moves with time in a display surface of the screen panel 52 can be realized. Accordingly, the advertising effect can be further heightened.

The present invention is not restricted to above mentioned embodiments according to the invention. For instance, examples of configurations in which, for instance, display surfaces of the screen panels 15a, 15b and 41a through 41d are curved with predetermined curvatures are described. However, in place of these, a planarly formed screen panel can be adopted as well. Furthermore, the advertising device 1 having two screen panels 15a, 15b and the advertising device 1A having four screen panels 41a through 41d are exemplified above. However, the number of the screen panels is not restricted thereto and can be arbitrarily defined. Still furthermore, the advertising device 1B having a cylindrical screen panel 52 is exemplified above. In place of the screen panel 52, various kinds of screen panels having an elliptic sectional shape or formed into a polygonal cylinder may be adopted. Furthermore, the optical engine 12 that uses LEDs as a light source is exemplified above. However, in place of the LEDs, an optical engine that uses a high-pressure mercury-vapor lamp or a metal halide lamp as a light source can be adopted. Still furthermore, an example where the liquid crystal light valve is adopted as a light modulation device is exemplified above. However, in place of the liquid crystal light valve, a reflective light modulation device can be adopted. Furthermore, a configuration example in which the optical system 17 (optical system 17A or 17B) is disposed in the display unit 3 (display unit 3A or 3B) is exemplified above. However, a configuration in which the optical system 17 (optical system 17A or 17B) can be partially or entirely disposed in the projection unit 2 (projection unit 2A or 2B) may be adopted.

1. An advertising device comprising:
a projection unit in which an optical engine that emits projection light is housed; and
a display unit provided with a screen that displays an image when the projection light is projected from a rear surface side thereof;
wherein the projection unit and the display unit are separably integrated.

2. The advertising device according to claim 1, wherein the screen comprises a non-planar display surface.

3. The advertising device according to claim 1, wherein the display unit comprises a plurality of the screens, and at least one of the projection unit and the display unit comprises an optical system that optically divides and projects the projection light on the respective screens.

4. The advertising device according to claim 1, wherein the display unit comprises a plurality of the screens, and at least one of the projection unit and the display unit comprises an optical system that switches a reflection direction of the projection light among the respective screens.

5. The advertising device according to claim 1, wherein the screen is cylindrical, at least one of the projection unit and the display unit comprises an optical system that continuously varies a reflection direction of the projection light and scans a projection area of the projection light along the screen with time.

6. An advertising device comprising:
a projection unit housing an optical engine that emits projection light; and
a display unit including a screen that displays an image when the projection light is rewardly projected thereon;
wherein the projection unit and the display unit are removably coupled to one another.

7. The advertising device according to claim 6 wherein:
the projection unit further comprises a first chassis;
the display unit further comprises a second chassis;
the first chassis and second chassis are removably coupled to one another.

8. The advertising device according to claim 7 wherein:
the first chassis further comprises:
a top end portion and a bottom end portion spaced apart from the top end portion; and
first linking tabs provided at the top end portion;
the second chassis further comprises:
a top end portion and a bottom end portion spaced apart from the top end portion; and
second linking tabs provided at the bottom end portion; and
the first linking tabs selectively engage and disengage the second linking tabs.
